(19) United States
(12) Patent Application Publication
(10) Pub. No.: US 2009/0305213 A1
(43) Pub. Date: Dec. 10, 2009

(54) SIMULATIONSVORRICHTUNG ZUM SIMULIEREN VON EINDRINGVORGÄNGEN

(76) Inventors: Rainer Burgkart, Munchen (DE); Robert Riener, Wangen (CH)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 12/158,840

(22) PCT Filed: Dec. 23, 2006
(86) PCT No.: PCT/DE2006/002344

§ 371 Date: Feb. 26, 2009

(30) Foreign Application Priority Data
Dec. 23, 2005 (DE) 10 2005 062 610.6
Dec. 23, 2005 (DE) 10 2005 062 611.4

(51) Int. Cl. G09B 23/30

(52) U.S. Cl. 434/267

(57) ABSTRACT

The invention relates to a simulation device for simulating penetration processes, carried out by a needle- or pin-like instrument or tool, the simulation device comprising: a handle (1), connected to the instrument (2) in a movable manner, the handle (1) being held by an operator, a position determining device (7), which determines the position of the instrument (2) relative to the handle (1) and generates a position signal, a force determining device (6), which determines the force with which the instrument (2) is forced against the body (8) by means of the handle, said force determining device (6) generating a force signal, a controllable actuator for displacement of the instrument (2) relative to the handle (1) and a computing and control unit with a signaling connection to the actuator,; said computing and control unit comprising a memory in which penetration information specific to the body and a computer program are stored and, based on the position and force signals, the actuator is controlled such that on pressing the instrument (2) against the body (8) the same tactile sensation is generated as on handling a real instrument inserted into a real body.

The invention relates to a simulation device for simulating penetration processes carried out by using a needle-like or pin-like instrument or tool, wherein the term instrument is used in the following description only.

In the field of medicine, for example, penetration of instruments such as hollow needles and catheters into a human or animal body is one of the routines most frequently performed in hospitals day by day. However, such routines must be trained because an executing individual, i.e. an operator, does not receive visual information on the position of the tip of a needle without using additional aids, so that all he/she can do is to rely on his/her haptic feeling, that is, the tactile sensation.

Numerous injection simulators are known from prior art, which were designed for different exercising cases, e.g. a model for exercising the puncture into blood vessels, as described in DE 44 14 832 and also in GB 2 288 686 A or WO 03/054834 A1.

Learning of the techniques described above by using simulators presupposes that the learner receives a realistic total impression as far as possible when exercising on it. However, if the realistic total impression can not be received by means of the simulator, there is the danger that the learner will be trained wrongly and will make mistakes when transposing the acquired capabilities onto a living patient, which possibly lead to injure this individual. Exercising and training on a simulator shall help to prevent such injuries from occurring.

A special problem arising with so-called haptic simulators, that is, with simulators based on counterforce feedback, is the partly heavyweight and bulky structures of the feedback equipment, which effect that the simulation conditions are unlike the conditions prevailing with a living patient.

Furthermore, all of the previous haptic simulators are designed for a very narrowly limited working area, wherein the working area is understood to be that body surface of a patient, for example, on which, at first, the exercising individual has to select the correct point of penetration and, if need be, to determine precisely the point of penetration by feeling it with fingers. Such exercises are indispensable for an individual who wants to become a doctor. In other words, the exercising individual must be able to guide the instrument correctly after having stabbed it and also must learn to hit the correct point of penetration.

Haptic injection simulators known from prior art, which work based on counterforce feedback, do not enable the simulator to be put onto an arbitrary point of any body, onto the back of a living patient, for example, or onto an arbitrary point of an anatomic model made of plastics. This is mainly caused by the necessary mechanical connection means between the instrument manually guided by the exercising individual and the force-based feedback equipment which, in most cases, is secretly integrated in the anatomic model, out of which another disadvantage results, that is, the design draft of a haptic injection simulator is not applicable with living patients, wherein the term “injection simulator” is to be understood in the broad sense as mentioned at the beginning of the explanations.

In summary, it must be stated that all of the haptic injection simulators known from prior art show two disadvantages conditioned by the system:
a. Simulation can not be carried out on a living body (human, animal).
b. “Searching and finding of the correct point of puncture” can not be learned, too.

Therefore, object of the invention is to provide a simulation device with which the deficiencies a and b according to the prior art are overcome.

The object of overcoming the deficiency a is solved by a simulation device according to claim 1. The object of overcoming the deficiencies a and b is solved by a simulation device according to claim 5.

The simulation device for simulating the penetration of an instrument into a body comprises a handle by which the device is manually guided by an operator. The instrument is coupled to the handle so that it can be moved into a predetermined direction relative to the handle, that is, the instrument is moved into the handle when pressed against a body. By this, a learner and an observer receive the optical impression as if the instrument would actually penetrate into the body, though it is moved into the handle.

An expert certainly knows that the movement of the instrument into the handle can be substituted by equivalent measures acting in the same way. For example, there is the possibility to form the instrument like a telescope, that is, it can consist of several tubes movable into each other.

In addition, a position determining device is provided, which determines the actual position of the instrument with respect to the handle and generates an actual position signal. Expressed more clearly, it is necessary to give information on the movement of the instrument tip relative to the handle.

Furthermore, a force determining device is provided, which determines the actual force with which the instrument is pressed against a body through the handle, wherein the force determining device generates an actual force signal.

Furthermore, a computer-controlled actuator is provided, which causes the instrument to be moved into the handle only when a predetermined force is applied. This actuator is connected with the position determining device, the force determining device and the computer via signal passages.

The actuator is controlled based on the evaluation of the actual force signal and the actual position signal. To realize this, a computer program is used, which simulates the material properties of the body in form of control signals for the actuator. This coherence is described in more detail as follows.

The actuator is integral part of the handle or connected to it on the outside thereof through a coupling element. For example, a hydraulic hose is suited as coupling element.

In the following, the control philosophy is qualitatively described comprehensively so that an expert in the field of control engineering will be able to construct the simulation device.

Aim is to simulate the penetration of a needle into a portion of a living human or animal body. It is to be simulated that the surface of this body portion is formed by a skin, followed by a fatty tissue, a connective tissue, a thick muscle tissue and a strong bony tissue. With the exception of the bony tissue, all of these tissues are to be penetrated. However, these tissue layers of the body portion are fictive ones, that is, are represented as software model only in the computer.

As the simulation serves to exercise the penetration of an instrument into a real body manually, it is expedient to carry out the exercise not only on a model body but also on a living body in order to increase the success of learning. For the sake of completeness, it should be mentioned that also then, when the body portion to be penetrated is made of a plastic material (e.g. an anatomic model), the haptic effect gained with the simulation is the same as that with a portion of a living body.

When an operator presses the simulation device onto a soft portion of a living body, the needle must be prevented from penetrating the skin actually, that is, the tip of the needle must be designed so that it is not capable of penetrating the skin during the simulation. This is gained by a needle having a relatively wide area at its tip. For example, a small disc made of plastic material can be fixed to the tip of the needle.

When an operator puts the needle with the plastic disc attached onto the body and presses it against the surface of skin thereof, the pressure generated by this action is determined by the force determining device. When the operator increases the force, penetration of the needle into the skin is simulated so that the actuator suddenly moves the needle into the handle by a small amount, that is, the penetration of the skin and the fatty tissue following it is simulated so that the needle touches the connective tissue. The actuator enables the needle to be further moved into the handle only when the operator increases the force to a value really required to press the needle against the relatively strong connective issue. The next step is to simulate the penetration of the muscle tissue, which is indicated by further moving the needle into the handle specifically. Finally, the needle touches the bony tissue which can not be penetrated, so that, when the operator further increases the force, he/she will feel a strong resistance caused by blocking the actuator.

In order to understand this procedure more clearly, a simulation example was selected, with which a needle, an other instrument or tool is used to penetrate layers of tissue having different strengths. It must not especially be mentioned that the same philosophy of control can be applied to tissues and materials having no in-homogeneities or small ones only. It is also obvious that the forces required for penetrating the tissues are dependent not only on the depth of penetration but also on the speed of penetration. After a stop (interruption of hand movement), when the penetration procedure is started again, there is the possibility that increased forces for overcoming the static friction are required, that is, so-called “stick and slip effects” occur, which can also be simulated. An expert certainly knows that also shape and nature of the instrument must be considered in the software.

The concrete construction of each of the components of the simulation device, i.e. the handle, the actual instrument, the mechanical guide of the instrument, the position determining device, the force determining device and the actuator, is selected by an expert on the basis of geometrical and structural requirements so as to satisfy the situation of exercise, wherein embodiments on principle are claimed in the sub-claims.

According to claim 2, the actuator, i.e. that part thereof which generates the driving force is arranged in or on the handle. It is possible to accommodate a screw-nut unit in the handle, for example, wherein the screw is driven by an electric motor and the nut, which is moved by the spindle, is fixedly connected with the instrument.

According to claim 3, the position determining device is arranged in or on the handle. An angle sensor can be arranged in the handle to detect the rotational movement of the screw according to claim 2. The actual position of the needle can be determined from the value detected by the angle sensor.

According to claim 4, the force determining device is arranged in or on the handle. A force sensor can be accommodated in or on the handle so that the force, which is generated when the instrument is pressed against a body through the handle, is transmitted to the force sensor. When a screw-nut unit is used, the force sensor has to be arranged between the instrument and the nut.

According to claim 5, an orientation determining device is arranged, which determines the actual spatial orientation of the instrument relative to a body and, based on the determined orientation, sends a corresponding electric signal to the computing and control unit. Such orientation determining devices are generally known as navigation systems and therefore, it is only necessary to select an orientation determining device matching to the respective case of application and a suitable signaling connection. For example, this further development of the invention enables direction-dependant properties of a body to be simulated or to learn placing the instrument onto the medically correct point of the body surface (e.g. in the area of the spine) and invading it into the body at the medically correct spatial angle, in a simulated manner.

According to claim 6, an optical navigation device known to an expert is used, wherein navigation marks are provided on the handle and the body, which are detectable by a camera system used with the optical navigation.

According to claim 7, simulation is performed on a model in the shape of a solid body, on a portion of the back thereof, for example, to exercise penetrating of the instrument in the region of spine. This body model is coupled with a force measuring device generating electric signals, from which the actual spot where the instrument tip is placed on the body model can be calculated. This technology is known to an expert and, for example, is described in detail in DE 102 61 673 A1.

Below, the invention is described in detail by means of schematic drawings.

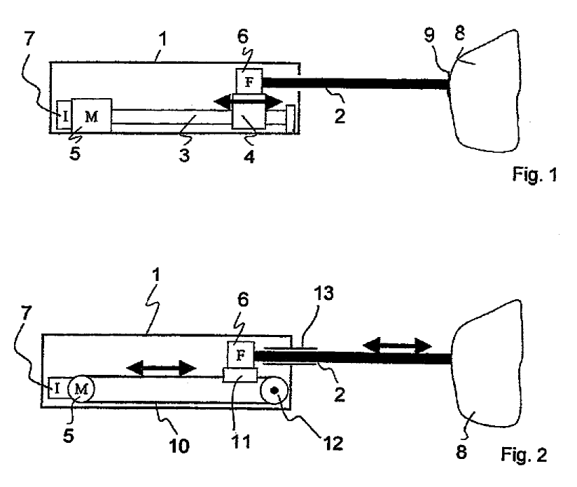

FIG. 1 shows a first embodiment of the invention.

FIG. 2 shows a second embodiment of the invention.

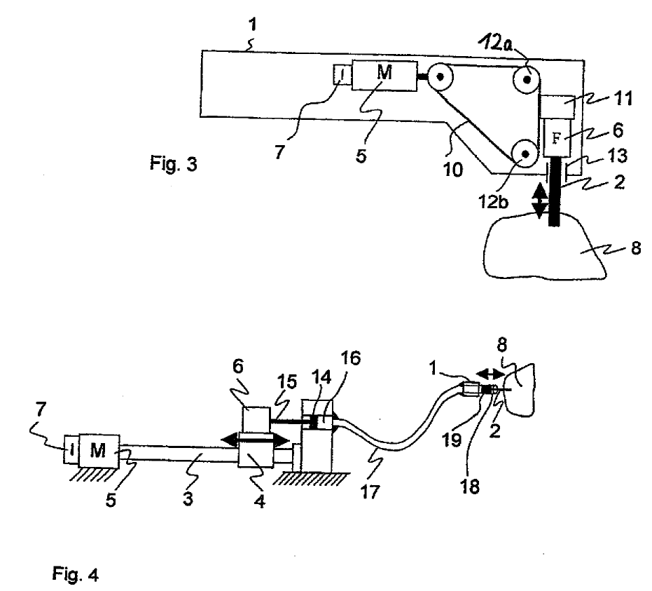

FIG. 3 shows a third embodiment of the invention.

FIG. 4 shows a fourth embodiment of the invention.

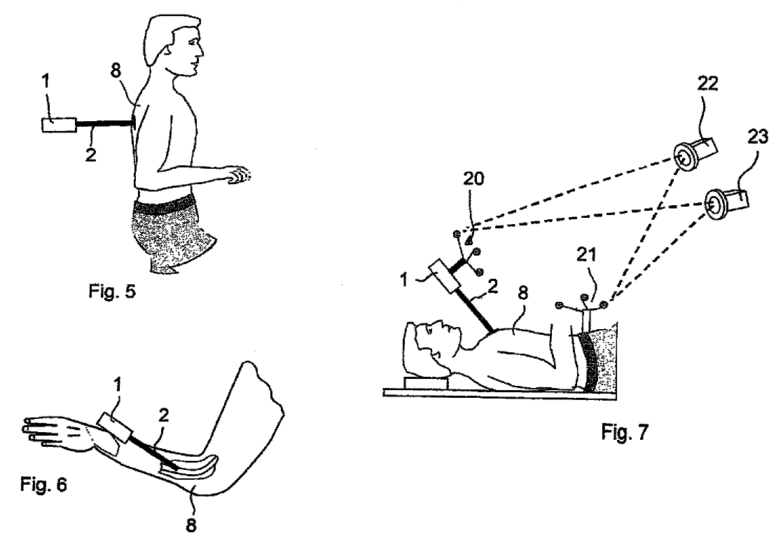

FIG. 5 shows a first application of the invention.

FIG. 6 shows a second application of the invention.

FIG. 7 shows a first application of the invention, with a navigation system integrated.

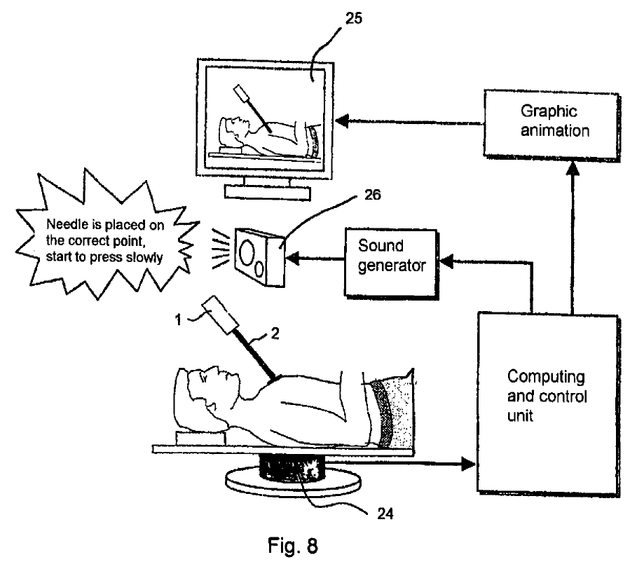

FIG. 8 shows a second application of the invention, with a navigation system integrated.

FIG. 1 shows the first embodiment of the invention, that is, a simulation device provided with a handle 1 by which the device is manually guided by an operator. The instrument is a needle 2 connected with the handle 1, wherein the needle 2 can be moved relatively to the handle 1, as indicated by an double arrow.

A screw-nut unit 3, 4 as actuator is integrated in the handle 1, wherein the screw 3 is driven by an electric motor 5 also integrated in the handle 1. The nut 4 being moved along the screw 3 is fixedly connected with the needle 2 through a force sensor 6. An incremental angle measuring system 7 is coupled to the electric motor 5. When the screw 3 is rotated by the electric motor 5, the nut 4 is moved forwardly or backwardly in the directions indicated by the double arrow. The distance which the needle 2 is moved can be determined from the pitch of the screw 3 and from the change of angle detected by the angle measuring system 7.

When the penetration of the needle 2 into a living body such as a human back according to FIG. 5 or into a forearm according to FIG. 6 is to be exercised, the needle is moved into the final position, as shown in FIG. 1. Then, the operator places the needle 2 onto the body 8 and presses it against the surface thereof with a force medically predetermined. In order to prevent the needle 2 from penetrating the outer skin and actually entering the body when the pressure is further increased, a disc 9 made of plastic material is stuck onto the skin at the assigned point of penetration. The disc 9 is provided with a small recess, into which the needle tip is inserted in order to prevent the needle tip from slipping off the disc. However, the disc 9 can be substituted by a small ball which is fixed at the needle tip.

The force applied onto the needle by an operator through the handle is measured by the force sensor 6 and transformed into an electric signal which is transmitted to a computer. A software is stored in the computer, which imitates the material properties of the body in shape of control signals for the actuator and controls the motor 6. For example, when the mode “puncture of spinal cord” is set, the software is activated, which imitates the properties of the material present between the outer skin and the spinal column of the body. However, when an injection into a vein of the forearm is to be simulated, the mode “vein injection at the forearm” is chosen.

An operator uses the simulation device like a real medical instrument and, therefore, performs the same medically determined movements as under real conditions. When a predetermined pressure is applied, the needle 2 is moved into the handle by a certain distance, which simulates that the outer skin has been penetrated. Dependent on the penetration force applied by the operator and on the situation if he/she goes on moving the needle or stops it, that is, if or not the penetration force is kept, the needle is moved into the handle by a longer or shorter distance. An expert in the field of automatic control engineering knows that the control circuit necessary for realizing the simulation must comprise a dynamic behavior such that the needle is moved by the screw-nut unit 3, 4, 5 as fast as in the case of using a real needle under real conditions.

In the following, further embodiments of the invention are described by means of FIGS. 2 to 4. In order to prevent repetitions, only features and functions deviating from those of the embodiment according to FIG. 1 are described.

FIG. 2 shows an embodiment of the invention, which uses an actuator in form of a tackle-carriage unit 10, 11. As the tackle does not comprises that inherent rigidity as the screw 3 used in the embodiment according to FIG. 1, a guide 13 in shape of a shell is provided to guide the needle 2. The carriage 10 is fixed to a rope 10 movable by the motor 5 in the directions indicated by a double arrow.

FIG. 3 shows an embodiment where the tool 2 is arranged at right angles relative to the handle 1, wherein the rope 10 is driven by the motor 5 and moved around two guide rollers 12a and 12b.

FIG. 4 shows a fourth embodiment of the invention, that is a simulation device equipped with hydraulic cylinders. The first hydraulic cylinder is operated by the screw-nut unit 3, 4 shown in FIG. 1. The first piston 14 is connected with the force sensor 6 through a piston rod 15 and displaces the hydraulic fluid in the first cylinder 16. The displaced hydraulic fluid passes a flexible hydraulic line 17, enters the second hydraulic cylinder 18 and displaces the piston 19 thereof, which the needle 2 is connected with. In principle, the mode of operation of this embodiment is the same as that of the first embodiment. However, the flexible hydraulic line 17 arranged between the hydraulic cylinders is advantageous in that the handle 1 can be made very small in size, because the second hydraulic cylinder only is accommodated in it.

FIGS. 5 and 6 show how this penetration device is used on the back and on the forearm of a living human body, respectively.

FIG. 7 shows an embodiment of the invention, which uses an optical navigation system 20 to 23 for detecting the actual spatial orientation of the needle 2 at a predetermined penetration point on a patient 8, with the navigation system generating an electric orientation signal which is transmitted to the computing and control unit. Three navigation points each are denoted by marks 20 and 21, wherein the navigation points 20 define the orientation of the needle and the navigation points 21 define the position of the patient. The navigation points are optically detected by cameras 22 and 23, which are spatially arranged to each other in a predetermined manner, and are used to ascertain the spatial orientation of the needle 2. All of the data detected by the cameras are transmitted to a computer.

Generally, the optical navigation procedure is well known to an expert so that a detailed explanation can be dispensed with. From the electric positioning signal generated by the computer it can be determined precisely if the needle is placed at the medically exact point and at the correct angle. With this application of the invention, a living patient and also a model made of plastic material can be used. When exercises on a living patient are performed, the instrument tip must be provided with a stitch-roof plate in order to prevent the patient from being injured by it.

FIG. 8 shows an application of the invention, where the simulation device is equipped with a navigation system which is based on the detection of forces and torques. With this application of the invention, only a model made of plastic material and having a high inherent rigidity can be used. This model is rigidly fixed on a multi-component load cell 24. When the instrument 2 is pressed onto the chest of a patient by means of the handle 1, the multi-component load cell 24 generates signals from which the point where the instrument tip is placed is calculated. By using a graphic animation, the correct or incorrect position of this point can be shown on a screen 25. It is also possible to acoustically indicate the correct or incorrect position of this point by using a loudspeaker 26.

As indicated on the screen 25, the instrument 2 already has penetrated the chest.

It is not necessary to mention that the controllable actuator for displacing the instrument 2 relative to the handle 1 in a defined manner has to be connected to the calculating and control unit via signal transmission. The signal transmission can be carried out via an electric control line but also wireless by using a radio link. This connection is not shown in the drawings in order to keep the clearness.

However, it must be emphasized that, with this invention, simulation devices can be provided for the first time, with which the instrument can be placed freely selectable onto any arbitrary point of a body so that also finding of the penetration point on a body can be exercised successfully by using this technology.

1. Simulation device for simulating penetration processes of an instrument (2) into a body (8), wherein the simulation device comprises:
a handle (1), connected to the instrument (2) in a movable manner, wherein the handle is held by an operator,
a position determining device (7), which determines the actual position of the instrument (2) relative to the handle (1) and generates an actual position signal,
a force determining device (6), which detects the actual force with which the instrument (2) is pressed against the body (8) by means of the handle (1), wherein the force-determining device (6) generates an actual electric signal,
a controllable actuator (3, 4, 5, 7; 10, 11, 5, 7; 10,12, 5, 7; 3, 4, 14, 15, 16, 17, 18, 19) for displacing the instrument (2) relative to the handle (1) in a defined manner and
a computing and control unit with a signaling connection to the actuator (3, 4, 5, 7; 10, 11, 5, 7; 10,12, 5, 7; 3, 4, 14, 15, 16, 17, 18, 19), wherein the computing and control unit comprises
a memory in which penetration information specific to the body and
a computer program are stored and, based on the actual position and force signals, the actuator is controlled so that, on pressing the instrument (2) against the body (8), an operator feels the same counter pressure, that is, has the same tactile sensation as on handling a real instrument inserted into a real body.

2. Simulation device according to claim 1, characterized in that the actuator is arranged in or on the handle.

3. Simulation device according to claim 1 or 2, characterized in that the position determining device is arranged in or on the handle.

4. Simulation device according to any of the preceding claims, characterized in that the force determining device is arranged in or on the handle.

5. Simulation device according to any of the preceding claims, characterized in that an orientation determining device (20, 21, 22, 13) is provided, which determines the actual spatial orientation of the tip of the instrument (2) relative to the body (8) and generates an electric orientation signal being transmitted to the computing and control unit.

6. Simulation device according to claim 5, characterized in that navigation marks (20, 21) are attached to the handle and to the body, which are perceptible by a camera system (22,23) used for optic navigation.

7. Simulation device according to claim 5, characterized in that
a rigid body model (8) is used, which is coupled to a force measuring device (24), and
a data processing program is implemented in the computing and control unit, wherein the force measuring device is designed so as to image the forces and torques occurring when the body model is touched and to provide them as electric measuring signals, and the data processing program is designed so as to determine the actual point of force application of the instrument tip, based on the measuring signals.
